(19) United States
(12) Patent Application Publication
(10) Pub. No.: US 2006/0273000 A1
(43) Pub. Date: Dec. 7, 2006

(54) Portable water filtering device

(76) Inventor: Liao I. Chung, Taichung City (TW)

Correspondence Address: PRO-TECHTOR INTERNATIONAL SERVICES, 20775 NORADA CT., SARATOGA, CA, 95070, US

(21) Appl. No.: 11/146,475

(22) Filed: Jun. 7, 2005

(51) Int. Cl. B01D 35/26

(52) U.S. Cl. 210/416.1

(57) ABSTRACT

A portable water filtering device includes a body including a filtering tube and a pump between which a pipe is connected. Water enters the pump from a bottom thereof and is pumped into the filtering tube via operation of the piston of the pump so that the water pump into the filtering tube and forcibly passes through a filtering member in the filtering tube. The body is received in a base and a cup is removably mounted to the base so that the filtered clean water can be collected in the cup.

### FIELD OF THE INVENTION

The present invention relates to a portable water filtering device which includes a manually operated pump to force water through filtering member so as to obtain clean water.

### BACKGROUND OF THE INVENTION

A conventional portable water filtering device generally includes a filtering member and water passes through the filtering member by gravity. However, the way that water passes through the filtering member by gravity is so slow that the volume of filtered clean water cannot meet need. Some water filtering devices are equipped with a pump which force water to go through filtering member so as to quickly get filtered clean water. Nevertheless, the pump is powered by electric power and the whole device is bulky and not suitable to carry.

The present invention intends to provide a portable water filtering device that includes a pump operated by manual way so as to have filtered cleaned water quickly.

### SUMMARY OF THE INVENTION

The present invention relates to a portable water filtering device that comprises a body including a filtering tube and a pump which is connected to the filtering tube side by side. A bottom cap is connected to a lower end of the pump and includes an inlet and an outlet. A pipe is connected between the bottom cap and the filtering tube. A piston has a first end movably inserted in the pump and a handle is connected to a second end of the piston. A filtering member is received in the filtering tube and a bottom cover is connected to a lower end of the filtering tube. A top cover is connected to a top of the filtering tube and includes a hole with which a pipe is connected. A base has a receiving space for receiving the body and a cup is removably mounted to the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the portable filtering device of the present invention;

FIG. 2 is a perspective view to show the portable filtering device of the present invention;

FIG. 3 is a cross sectional view to show the portable filtering device of the present invention;

FIG. 4 shows water is pumped into the filtering tube by operating the piston of the pump;

FIG. 5 shows that the cup is removed from the base and the pump is operated, and

FIG. 6 is a perspective view to show the body of the portable filtering device of the present invention.

### DETAILED DESCRIPTION OF THE PREFERRED EMBODIMENT

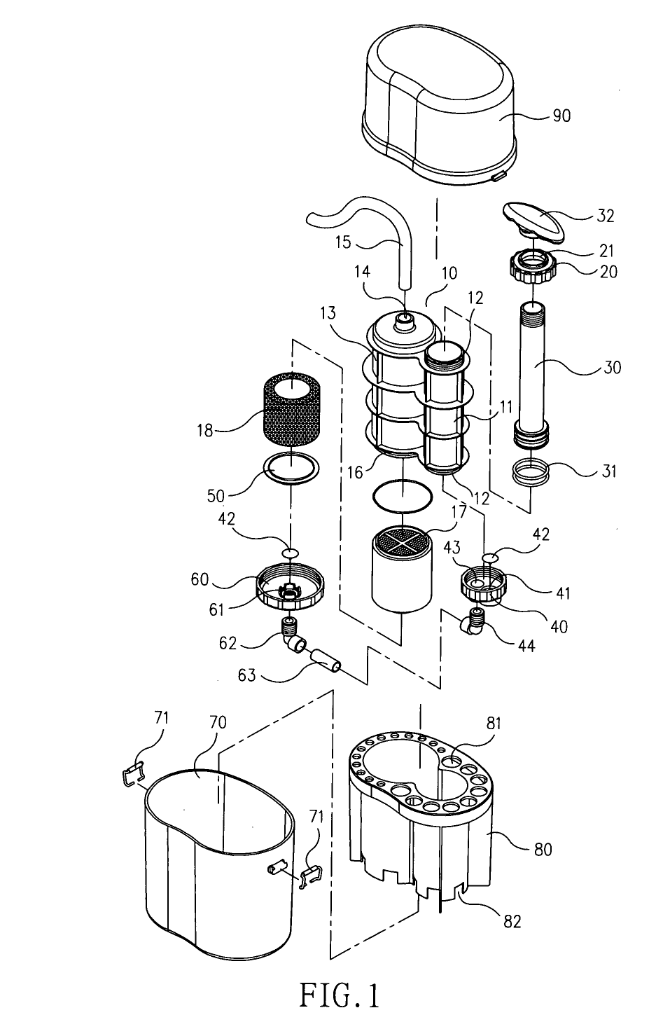

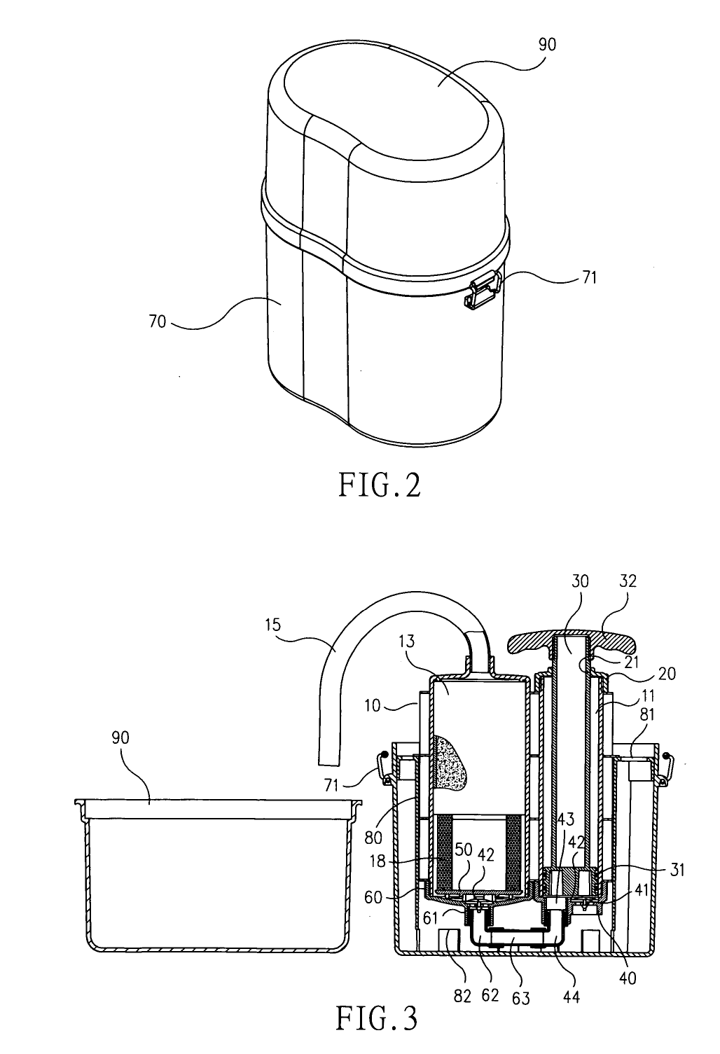

Referring to FIGS. 1, 2, 3 and 6, the portable filtering device of the present invention comprises a body 10 including a filtering tube 13 and a pump 11 which is connected to the filtering tube 13 side by side. The pump 11 includes two threaded sections 12 on two ends thereof and a bottom cap 40 is threadedly connected to the threaded section on a lower end of the pump 11. The bottom cap 40 includes an inlet 41 and an outlet 43, wherein a one-direction valve 42 is received in the outlet 43. A piston 30 has a first end movably inserted in the pump 11 and seals 31 are connected to the first end of the piston 30. A collar is threadedly connected to a second end of the piston 30 and a handle 32 is connected to a central hole 21 of the collar 20.

A filtering member 18 is received in the filtering tube 13 and a bottom cover 60 is threadedly connected to a lower end of the filtering tube 13 with a seal 50 clamped between the bottom cover 60 and the lower end of the filtering tube 13. A hole 61 is defined through the bottom cover 60 and another one-direction valve 42 is received in the hole 61. A pipe 63 is connected between two fittings 44, 62 respectively connected to the bottom cap 40 and the bottom cover 60. A top cover is connected to a top of the filtering tube 13 and includes a hole 14 with which a pipe 15 connected.

A base 70 has a receiving space and a U-shaped support frame 80 is received in the space. The frame 80 includes a top opening through which the body 10 is engaged. A plurality of holes 81 are defined in a top surface of the support frame 80 and located around the top opening. A plurality of recesses 82 are defined through a lower edge of the support frame 80. A cup 90 is removably mounted to the base 70. Two fastening members 71 are pivotably connected to an outside of the base 70 and two lugs extend form an outside of the cup 90. The two fastening members 71 are secured to the lugs.

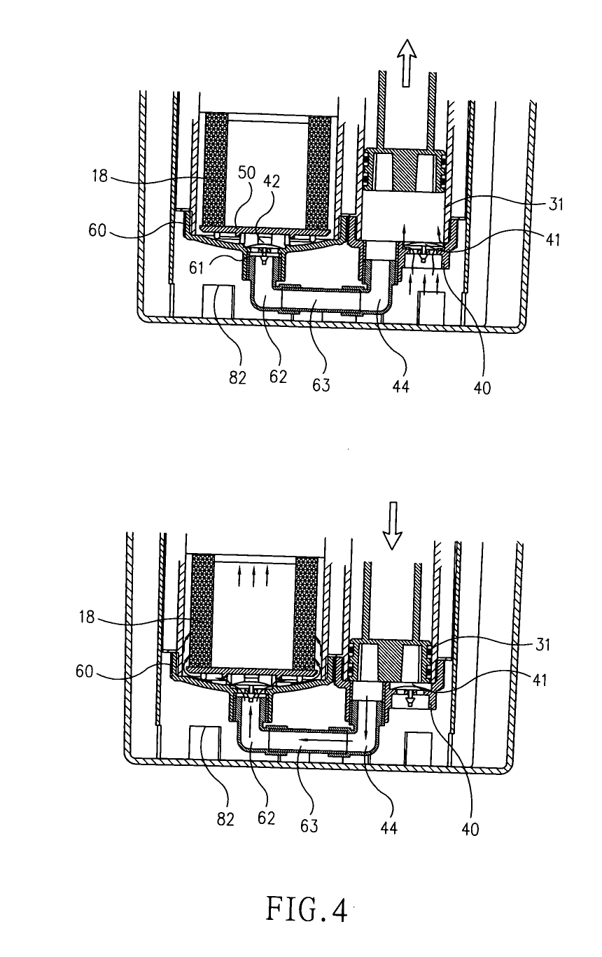

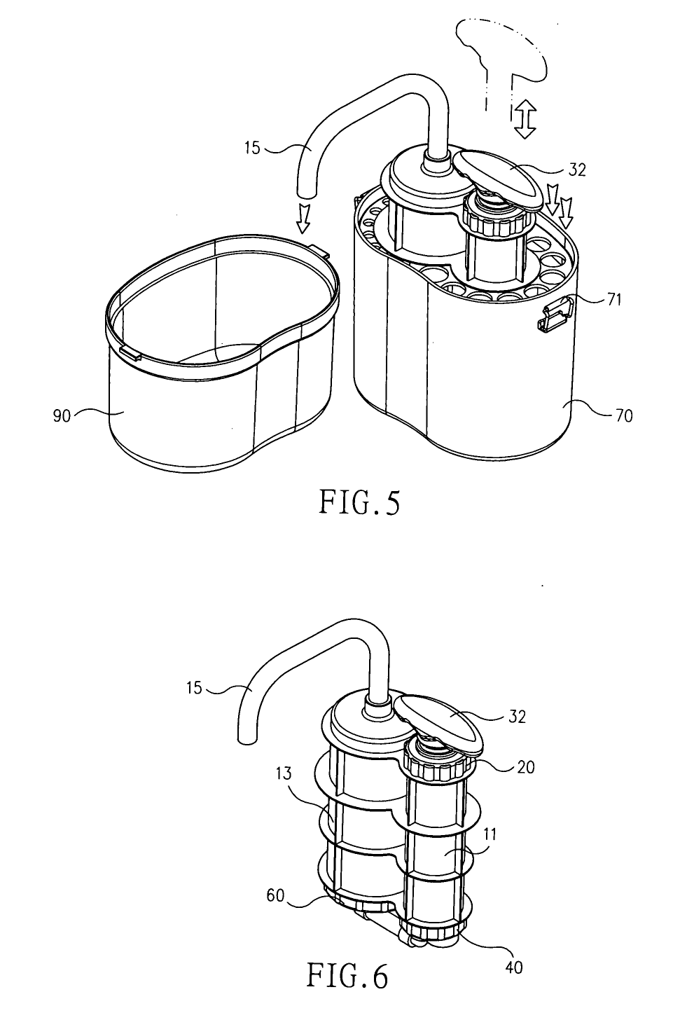

As shown in FIGS. 4 and 5, when using the device, the cup 90 is removed from the base 70 and water is filled in the base 70. The user holds the handle 32 and reciprocally operates the piston 30 to pump the water into the filtering tube 13 via the pipe 63 and the water forcibly passes through the filtering member 18 and flows out from the pipe 15. The filtered clean water is collected in the cup 90.

While we have shown and described the embodiment in accordance with the present invention, it should be clear to those skilled in the art that further embodiments may be made without departing from the scope of the present invention.

What is claimed is:

1. A portable water filtering device comprising:
a body including a filtering tube and a pump which is connected to the filtering tube side by side, a bottom cap connected to a lower end of the pump and including an inlet and an outlet, a one-direction valve received in the outlet, a piston having a first end movably inserted in the pump, a handle connected to a second end of the piston;
a filtering member received in the filtering tube and a bottom cover connected to a lower end of the filtering tube, a pipe connected between the bottom cap and the bottom cover, a top cover connected to a top of the filtering tube and including a hole with which a pipe connected, and
a base having a receiving space and the body received in the base, a cup removably mounted to the base.

2. The device as claimed in claim 1, wherein two fastening members are pivotably connected to an outside of the base and two lugs extend form an outside of the cup, the two fastening members are secured to the lugs.

3. The device as claimed in claim 1, wherein a U-shaped support frame includes a top opening through which the body is engaged, a plurality of holes are defined in a top surface of the support frame and located around the top opening, a plurality of recesses are defined through a lower edge of the support frame.
